(19) United States
(12) Patent Application Publication
(10) Pub. No.: US 2024/0021390 A1
(43) Pub. Date: Jan. 18, 2024

(54) RELAY WITH MAGNETIC STEELS FOR ARC EXTINGUISHING

(71) Applicant: XIAMEN GHGM INDUSTRIAL TRADE CO., LTD, XIAMEN (CN)

(72) Inventor: BINGSHUI CHEN, XIAMEN (CN)

(21) Appl. No.: 18/052,933

(22) Filed: Nov. 6, 2022

(30) Foreign Application Priority Data
Jul. 13, 2022 (CN) 202210818524.6

(51) Int. Cl. H01H 50/38; H01H 50/54

(52) U.S. Cl. CPC H01H 50/38; H01H 50/54

(57) ABSTRACT

A relay with magnetic steels for arc extinguishing includes connecting pieces having static contact points, moving spring pieces having moving contact points, a pushing piece linking to the moving spring pieces, and a driving piece providing power to the pushing piece. The static contact points are arranged on bottom ends of the connecting pieces. The moving contact points are arranged on top ends of the moving spring pieces and are arranged opposite to the static contact points. The moving contact points are controlled by the driving piece to contact or separate from the static contact points. The magnetic steels are arranged between the connecting pieces and the moving spring pieces. The magnetic steels are arranged on an outside of the connecting pieces and the moving spring pieces. Each of the magnetic steels is limited in a position to generate a bias magnetic field and performs an arc extinguishing operation.

### TECHNICAL FIELD

The present disclosure relates to a technical field of relays, and in particular to a relay with magnetic steels for arc extinguishing.

### BACKGROUND

A relay is an electrical control device, which is an electrical device that makes a predetermined step change of controlled quantity in an electrical output circuit when a change of input quantity meets a specified requirement. The relay has an interactive relationship with a control system and a controlled system, and is usually used in automated control circuits. The relay is actually an “automatic switch” that uses a small current to control an operation of a large current, so it plays a role of automatic adjustment, safety protection, and conversion circuit in the automated control circuits.

However, during use of the relay, at a moment when a switch thereof is turned off, electromagnetic energy needs to rely on breakpoints to generate a self-inductive high voltage to break down air to maintain a current, which generates an arc. A conventional relay has many shortcomings in arc extinguishing, which greatly affects a load of and service life of a product in which the conventional product is installed. Therefore, the conventional relay is hardly to be suitable for various use environments with multiple purposes.

### SUMMARY

In view of this, a purpose of the present disclosure is to provide a relay with magnetic steels for arc extinguishing, so as to solve above problems.

The present disclosure provides a relay with magnetic steels for arc extinguishing.

The relay with the magnetic steels for arc extinguishing comprises connecting pieces having static contact points, moving spring pieces having moving contact points, a pushing piece configured to link to the moving spring pieces, and a driving piece configured to directly provide power to the pushing piece. Each of the static contact points is arranged on a bottom end of a corresponding connecting piece of the connecting pieces. Each of the moving contact points is arranged on a top end of a corresponding moving spring piece of the moving spring pieces and is arranged opposite to a corresponding static contact point of the static contact points. Each of the moving contact points is controlled by the driving piece to contact or separate from the corresponding static contact point. The magnetic steels are arranged between the connecting pieces and the moving spring pieces. The magnetic steels are arranged on an outside of the connecting pieces and the moving spring pieces. Each of the magnetic steels is limited in a position of the relay. The position of each of the magnetic steels is defined as a middle position between a corresponding moving contact point and a corresponding static contact point along a vertical direction of the moving contact points and the static contact points when the moving contact points and the static contact points are in a separated state. The position of each of the magnetic steels is defines as an offset position along a horizontal direction of the moving contact points and the static contact points. Each of the magnetic steels is limited in the position to generate a bias magnetic field and is configured to reduce arcing.

Furthermore, two connecting pieces, two moving spring pieces, and two magnetic steels are provided. The two connecting pieces are matched with the two moving spring pieces. Each of the connecting pieces and each of the moving spring pieces are matched with a corresponding magnetic steel. The two magnetic steels are offset from each other to be adjacent to each other.

Furthermore, an orthographic projection of each of the magnetic steels is on a contact movement path of the corresponding moving contact point.

Furthermore, the magnetic steels are arranged on one side of the connecting pieces and the moving spring pieces or the magnetic steels are arranged on two sides of the connecting pieces and the moving spring pieces. The magnetic steels are configured as rectangular structures.

Furthermore, the relay further comprises a main body portion and a contact portion arranged on the main body portion. The driving piece is arranged in the main body portion; the connecting pieces are arranged opposite to the pushing piece. The connecting pieces are at least partially exposed outside the contact portion.

Furthermore, the magnetic steels are exposed outside the contact portion. The magnetic steels are separated from the moving contact points arranged in the relay and the static contact points arranged in the relay.

Furthermore, the contact portion comprises a shell. The shell is boss-shaped. An end face of a step of the shell is recessed to form installing grooves. Each of the installing grooves is configured to vertically install a corresponding magnetic steel. After each of the magnetic steels is arranged in the position of the relay, each of the magnetic steels is arranged in the shell.

Furthermore, the relay further comprises guiding grooves provided on one side of the step of the shell. The guiding grooves vertically penetrate an upper portion of the shell. Each of the guiding grooves is communicated with a corresponding installing groove.

Furthermore, top ends of the connecting pieces are configured as connecting portions having outer threads. A blocking wall is arranged between two magnetic steels arranged on a same side, the blocking wall is extended from the end face of the step. The blocking wall blocks the two magnetic steels arranged on the same side in a direction in which the two magnetic steels are exposed to the shell.

Furthermore, a housing of the main body portion is made of a magnetic conductive metal material. The housing at least covers an outer peripheral side of the driving piece to perform electromagnetic shielding.

By adopting above technical solutions, the relay of the present disclosure uses the magnetic steels arranged outside the moving contact points and the static contact points to extinguish arcs generated during connection and disconnection of the moving contact points and the static contact points. An arc is a gas discharge phenomenon, which has great harm to electrical devices. After each of the magnet steels is limited to the position of the relay, an arc extinguishing path is lengthened as much as possible. After the arc is lengthened, voltammetric characteristics of the arc are changed. The arc is lengthened along an axial direction of the arc, and is also lengthened along a direction perpendicular to the axial direction of the arc. The relay of the present disclosure significantly reduces an influence caused by the arcs.

In the present disclosure, each of the magnet steels is vertically arranged on the outside of the corresponding connecting piece and the corresponding moving spring piece on one hand and is arranged at a middle position relative to the corresponding connecting piece and the corresponding moving spring piece on the other hand. Further, each of the magnetic steels is horizontally offset relative to an adjacent magnetic steel, so after positions of the magnetic steels are limited, the bias magnetic field generated by each of the magnetic steels carries out the arc extinguishing operation with a large path, which greatly improves a path of the arc lengthened along the direction perpendicular to the axial direction of the arc. Further, the relay with the magnetic steels switches circuits with high current and high power, so as to realize a purpose of improving product performance and working reliability. Therefore, the relay with the magnetic steels is configured as a magnetic latching relay and an electromagnetic relay. In addition, the relay has effects of reasonable structure and reliable contact, and is widely used in a 24V direct current (DC) load switch in a vehicle assembly and a 48V DC breaker in a photovoltaic assembly.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor. In the drawing:

FIG. 1 is a structural schematic diagram of a relay according to one embodiment of the present disclosure.

FIG. 2 is a partial cross-sectional schematic diagram of the relay according to one embodiment of the present disclosure.

FIG. 3 is another partial cross-sectional schematic diagram of the relay according to one embodiment of the present disclosure.

FIG. 4 is a structural schematic diagram of the relay according to one embodiment of the present disclosure.

FIG. 5 is another structural schematic diagram of the relay according to one embodiment of the present disclosure.

FIG. 6 is a structural schematic diagram of magnetic steels on positions between moving contact points and static contact points of the relay according to one embodiment of the present disclosure.

FIG. 7 is an exploded schematic diagram of a contact portion of the relay according to one embodiment of the present disclosure.

FIG. 8 is a structural schematic diagram of the contact portion of the relay according to one embodiment of the present disclosure.

In the drawings:

1—connecting piece; 2—moving spring piece; 3—pushing piece; 4—static contact point; 5—moving contact point; 6—magnetic steel; 7—main body portion; 8—contact portion; 9—step; 10—installing groove; 11—guiding groove; 12—connecting portion; 13—blocking wall.

### DETAILED DESCRIPTION

In order to make objectives, technical solutions, and advantages of the present disclosure clearer, the following further describes the present disclosure in detail with reference to accompanying drawings and embodiments. It should be understood that the specific embodiments described here are only used to explain the present disclosure, but not to limit the present disclosure.

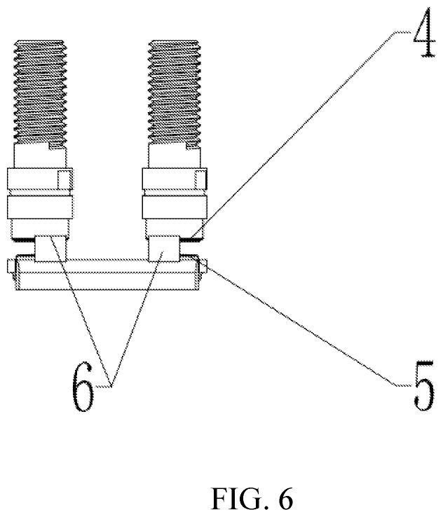

The present disclosure provides a relay with magnetic steels for arc extinguishing. The relay with the magnetic steels for arc extinguishing comprises connecting pieces 1 having static contact points 4, moving spring pieces 2 having moving contact points 5, a pushing piece 3 configured to link to the moving spring pieces 2, and a driving piece (not shown in the drawings) configured to directly provide power to the pushing piece 3. Each of the static contact points 4 is arranged on a bottom end of a corresponding connecting piece 1 of the connecting pieces 1. Each of the moving contact points 5 is arranged on a top end of a corresponding moving spring piece 2 of the moving spring pieces 2 and is arranged opposite to a corresponding static contact point 4 of the static contact points 4. Each of the moving contact points 5 is controlled by the driving piece to contact or separate from the corresponding static contact point 4. The magnetic steels 6 are arranged between the connecting pieces 1 and the moving spring pieces 2. The magnetic steels 6 are arranged on an outside of the connecting pieces 1 and the moving spring pieces 2. Each of the magnetic steels 6 is limited in a position of the relay. As shown in FIG. 6, the position of each of the magnetic steels 6 is defined as a middle position between a corresponding moving contact point 5 and a corresponding static contact point 4 along a vertical direction of the moving contact points 5 and the static contact points 4 when the moving contact points 5 and the static contact points 3 are in a separated state. The position of each of the magnetic steels 6 is defines as an offset position along a horizontal direction of the moving contact points 5 and the static contact points 4. Each of the magnetic steels 6 is limited in the position to generate a bias magnetic field and is configured to perform a large-path arc extinguishing operation.

The relay of the present disclosure uses the magnetic steels 6 arranged the outside of the moving contact points 5 and the static contact points 4 to extinguish the arc generated during connection and disconnection of the moving contact points 5 and the static contact points 4. The arc is a gas discharge phenomenon, which has great harm to electrical devices. After each of the magnet steels 6 is limited to the position of the relay, an arc extinguishing path is lengthened as much as possible. After the arc is lengthened, voltammetric characteristics of the arc are changed. The arc is lengthened along an axial direction of the arc, and is also lengthened along a direction perpendicular to the axial direction of the arc. The relay of the present disclosure significantly reduces an influence caused by the arc.

In the present disclosure, each of the magnet steels 6 is vertically arranged on the outside of the corresponding connecting piece 1 and the corresponding moving spring piece 2 on one hand and is arranged at a middle position relative to the corresponding connecting piece 1 and the corresponding moving spring piece 2 on the other hand. Further, each of the magnetic steels 6 is horizontally offset relative to an adjacent magnetic steel, so after the magnetic steels are limited, the bias magnetic field generated by each of the magnetic steels 6 carries out the arc extinguishing operation with a large path, which greatly improves a path of the arc lengthened along the direction perpendicular to the axial direction of the arc. Further, the relay with the magnetic steels switches circuits with high current and high power, so as to realize a purpose of improving product performance and working reliability. Therefore, the relay with the magnetic steels is configured as a magnetic latching relay or an electromagnetic relay. In addition, the relay has effects of reasonable structure and reliable contact, and is widely used in a 24V direct current (DC) load switch in a vehicle assembly and a 48V DC breaker in a photovoltaic assembly.

It should be mentioned that arrangements of the magnetic steels in the relay enables the relay of the present disclosure to be upgraded from being applied to a circuit with a load of 24 VDC and 300 A to be applied to a circuit with a load of 48 VDC and 200 A, which significantly improves a load capacity of the relay. Therefore, the relay of the present disclosure can be applied to both a small load and a larger load power consumption environment.

It should be mentioned that the driving piece configured to provide power to the pushing piece is an existing driving device, which is not shown in the embodiment. It should be understood that a direct-push driving device is a common structure in the prior art, and the direct-push driving device is held by the magnetic steels or by a current of a coil, so as to realize a linkage cooperation between the pushing piece 3 and the moving spring pieces 2.

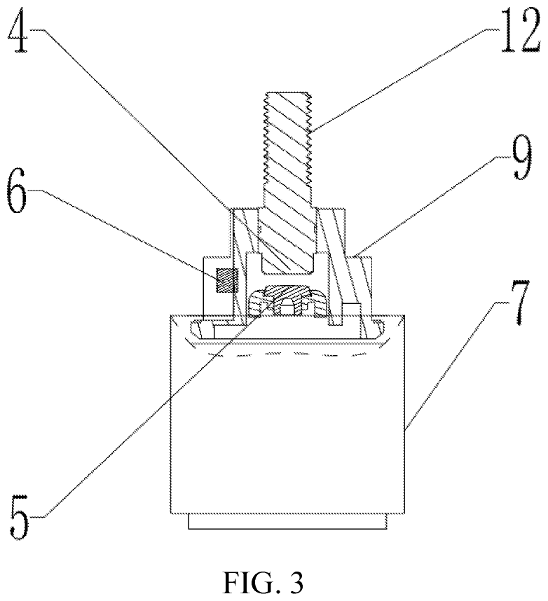

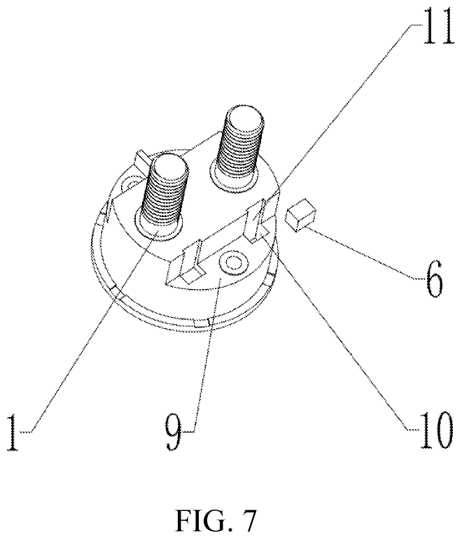

As shown in FIGS. 3, 6, and 7, in the embodiment, two connecting pieces 1, two moving spring pieces 2, and two magnetic steels 6 are provided. The two connecting pieces 1 are matched with the two moving spring pieces 2. Each of the connecting pieces 1 and each of the moving spring pieces 2 are matched with a corresponding magnetic steel 6. The two magnetic steels 6 are offset from each other to be adjacent to each other. In the embodiment, the two connecting pieces 1 cooperate with the two moving spring pieces 2 to form two point positions. The two point positions are capable of contacting and separating from each other. The magnetic steels 6 are arranged on an outer peripheral of the point positions to respectively extinguish the generated arcs at the point positions, which further realizes efficient arc extinguishing.

In addition, the two magnetic steels 6 are relatively horizontally offset, and the two magnetic steels 6 are offset to one side adjacent to each other, which greatly improves interaction between the bias magnetic fields generated by the two magnetic steels 6, improves a superposition effect between the bias magnetic fields generated by the two magnetic steels 6, and significantly improves an arc extinguishing effect.

In one embodiment, an orthographic projection of each of the magnetic steels 6 is on a contact movement path of the corresponding moving contact point 5. Each of the magnetic steels 6 is arranged opposite to a point position of the point position where the corresponding moving contact point 5 is separated from the corresponding static contact point 4. A projected position of each of the magnetic steels 6 after the offset is still within an active path (contact movement path) of the corresponding moving contact point 5. On a premise of ensuring the offset of the magnetic steels 6, the magnetic steels 6 are kept within a space where the arcs are effectively extinguished, and an overall layout of the relay is reasonably utilized.

The magnetic steels 6 are arranged on one side of the connecting pieces 1 and the moving spring pieces 2 or the magnetic steels 6 are arranged on two sides of the connecting pieces 1 and the moving spring pieces 2. The magnetic steels 6 are configured as rectangular structures. In one embodiment, the magnetic steels 6 for arc extinguishing are arranged on the one side of the connecting pieces 1 and the moving spring pieces 2, which ensures arc extinguishing efficiency on a basis of cost control. In another embodiment, the magnetic steels 6 are arranged on two opposite sides of the connecting pieces 1 and the moving spring pieces 2. Each two magnetic steels 6 for extinguishing arcs generated at a same point position cooperate with each other to perform arc extinguishing operations. That is, each two magnetic steels 6 cooperate with each other to realize an effect of multi-directionally lengthening the arcs.

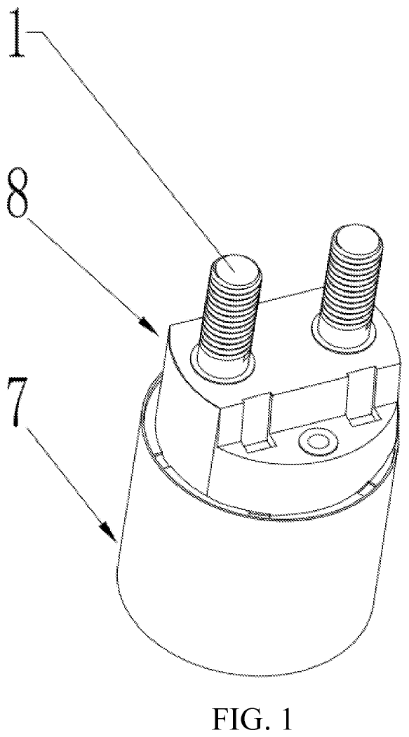

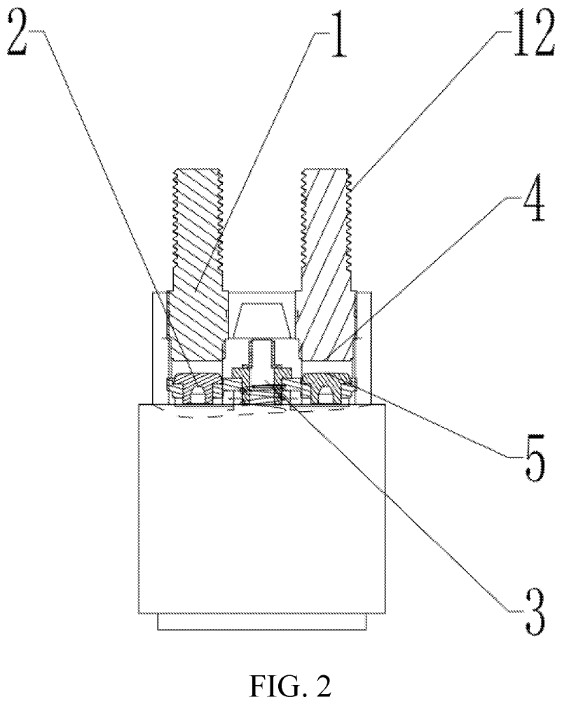

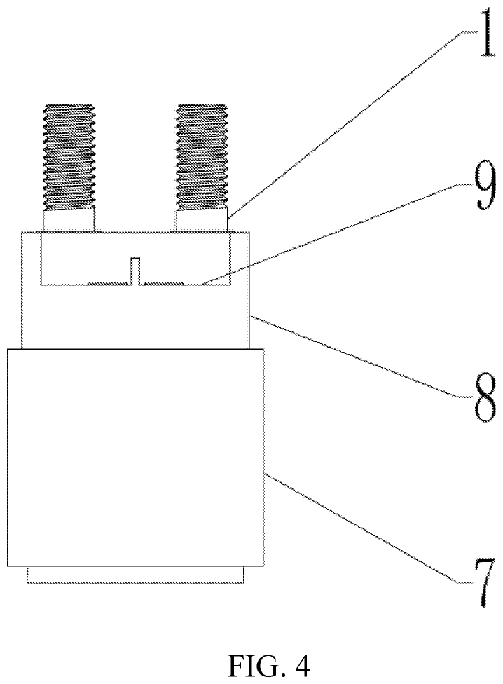

As shown in FIGS. 1-5, in one embodiment, the relay further comprises a main body portion 7 and a contact portion 8 arranged on the main body portion 7. The driving piece is arranged in the main body portion 7. The connecting pieces 1 are arranged opposite to the pushing piece 3. The connecting pieces 1 are at least partially exposed outside the contact portion 8. Obviously, the contact portion 8 is connected with an external electrical device through portions of the connecting pieces 1 exposed outside to form an electrical connection.

In one embodiment, the magnetic steels 6 are exposed outside the contact portion 8. The magnetic steels 6 are separated from the moving contact points 5 arranged in the relay and the static contact points 4 arranged in the relay, which increases a working temperature of the magnetic steels 6 and prevents magnetic decay of the magnetic steels 6.

Specifically, the contact portion 8 comprises a shell. The shell is boss-shaped. An end face of a step 9 of the shell is recessed to form installing grooves 10. Each of the installing grooves 10 is configured to vertically install a corresponding magnetic steel 6. Each of the magnetic steels 6 is arranged in the position of the relay and is arranged in the shell. In one embodiment, the relay further comprises guiding grooves 11 provided on one side of the step 9 of the shell. The guiding grooves 11 vertically penetrate an upper portion of the shell. Each of the guiding grooves 11 is communicated with a corresponding installing groove 10.

The installing grooves 10 are provided on the step 9 of the shell, and each of the installing grooves 10 and a corresponding guiding groove 11 cooperate with each other to realize an interference fit with a corresponding magnetic steel 6, thereby quickly limiting the corresponding magnetic steel 6 to a desired position. Each of the magnet steels 6 is assembled in the corresponding installing groove 10 of the shell and the installing position of each of the magnet steels 6 is at a position corresponding to the corresponding moving contact point 5 arranged inside the relay and the corresponding static contact point 4 arranged in the relay. The magnetic steels 6 are the rectangular structures, which is conducive to generations of the bias magnetic field and is conducive to corresponding arc extinguishing operations. Further, connection and cooperation of the guiding grooves 11 and the installing grooves 10 save assembly costs.

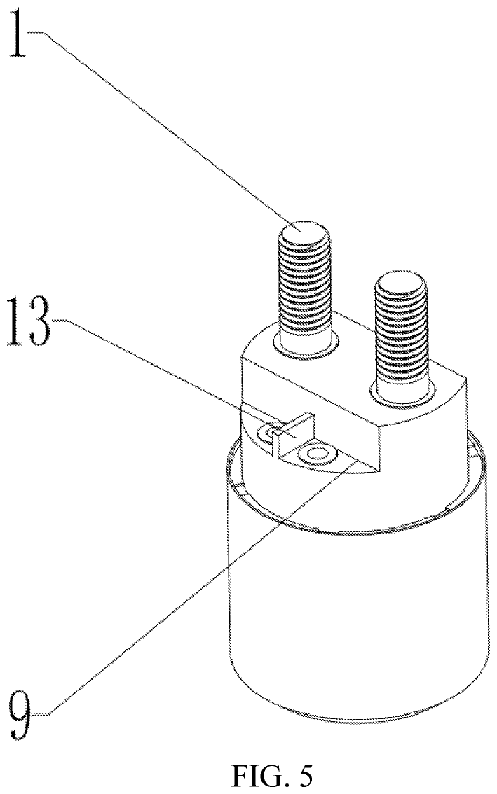

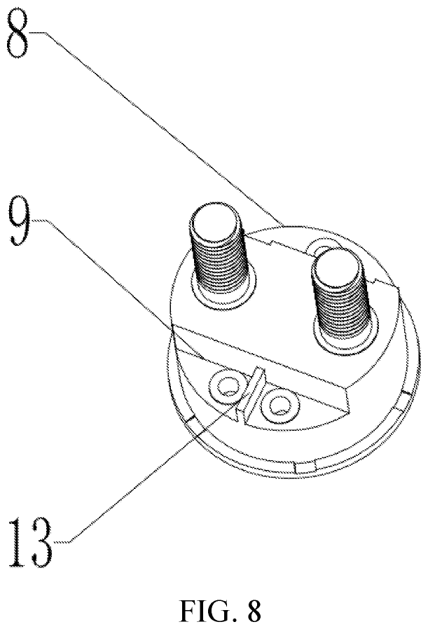

In addition, top ends of the connecting pieces 1 are configured as connecting portions 12 having outer threads, which facilitates quick connection or disconnection of the static contact points 4 and the external electrical devices through the external threads of the connecting pieces 1. As shown in FIGS. 5 and 8, a blocking wall 6 is arranged between the two magnetic steels 6 arranged on a same side. The blocking wall 6 is extended from the end face of the step 9. The blocking wall blocks the two magnetic steels 6 arranged on the same side in a direction in which the two magnetic steels 6 are exposed to the shell. Therefore, the two magnet steels are insulated from each other to prevent an occurrence of short circuit.

In one embodiment, a housing of the main body portion 7 is made of a magnetic conductive metal material. The housing at least covers an outer peripheral side of the driving piece to perform electromagnetic shielding.

In the embodiment, since the housing of the main body portion 7 is made of metal, external interference to the driving piece arranged in the relay is reduced, and the influence of the driving piece on the magnetic steels 6 exposed outside is relatively reduced.

The shell of the contact portion 8 is boss-shaped, and the step 9 of the shell is on an upper portion of the shell to facilitate the connection and the disconnection between the contact portion 8 and the external electrical device. Structures of the shell and the housing ensure a strength of the relay and provide a large internal space at the same time. In addition, the magnetic steels 6 are partially wrapped by the shell, and the housing completely encloses the driving piece arranged inside, which makes the configuration and layout of the overall relay good, and improves recognition and competitiveness of the relay.

Above are only optional embodiments of the present disclosure, and the protection scope of the present disclosure is not limited to the above-mentioned embodiments. All technical solutions that belong to the idea of the present disclosure belong to the protection scope of the present disclosure.

What is claimed is:

1. A relay with magnetic steels for arc extinguishing, comprising:
connecting pieces having static contact points,
moving spring pieces having moving contact points,
a pushing piece configured to link to the moving spring pieces, and
a driving piece configured to directly provide power to the pushing piece;
wherein each of the static contact points is arranged on a bottom end of a corresponding connecting piece of the connecting pieces; each of the moving contact points is arranged on a top end of a corresponding moving spring piece of the moving spring pieces and is arranged opposite to a corresponding static contact point of the static contact points, each of the moving contact points is controlled by the driving piece to contact or separate from the corresponding static contact point;
wherein the magnetic steels are arranged between the connecting pieces and the moving spring pieces; the magnetic steels are arranged on an outside of the connecting pieces and the moving spring pieces; each of the magnetic steels is limited in a position of the relay; the position of each of the magnetic steels is defined as a middle position between a corresponding moving contact point and a corresponding static contact point along a vertical direction of the moving contact points and the static contact points, when the moving contact points and the static contact points are in a separated state; the position of each of the magnetic steels is defines as an offset position along a horizontal direction of the moving contact points and the static contact points; each of the magnetic steels is limited in the position to generate a bias magnetic field and is configured to reduce arcing.

2. The relay with the magnetic steels for arc extinguishing according to claim 1, wherein two connecting pieces, two moving spring pieces, and two magnetic steels are provided; the two connecting pieces are matched with the two moving spring pieces; each of the connecting pieces and each of the moving spring pieces are matched with a corresponding magnetic steel; the two magnetic steels are offset from each other to be adjacent to each other.

3. The relay with the magnetic steels for arc extinguishing according to claim 2, wherein an orthographic projection of each of the magnetic steels is on a contact movement path of the corresponding moving contact point.

4. The relay with the magnetic steels for arc extinguishing according to claim 1, wherein the magnetic steels are arranged on one side of the connecting pieces and the moving spring pieces or the magnetic steels are arranged on two opposite sides of the connecting pieces and the moving spring pieces; the magnetic steels are configured as rectangular structures.

5. The relay with the magnetic steels for arc extinguishing according to claim 1, wherein the relay further comprises a main body portion and a contact portion arranged on the main body portion; the driving piece is arranged in the main body portion; the connecting pieces are arranged opposite to the pushing piece; the connecting pieces are at least partially exposed outside the contact portion.

6. The relay with the magnetic steels for arc extinguishing according to claim 5, wherein the magnetic steels are exposed outside the contact portion; the magnetic steels are separated from the moving contact points arranged in the relay and the static contact points arranged in the relay.

7. The relay with the magnetic steels for arc extinguishing according to claim 6, wherein the contact portion comprises a shell; the shell is boss-shaped; an end face of a step of the shell is recessed to form installing grooves; each of the installing grooves is configured to vertically install a corresponding magnetic steel; after each of the magnetic steels is arranged in the position of the relay, each of the magnetic steels is arranged in the shell.

8. The relay with the magnetic steels for arc extinguishing according to claim 7, wherein the relay further comprises guiding grooves provided on one side of the step of the shell; the guiding grooves vertically penetrate an upper portion of the shell; each of the guiding grooves is communicated with a corresponding installing groove.

9. The relay with the magnetic steels for arc extinguishing according to claim 7, wherein top ends of the connecting pieces are configured as connecting portions having outer threads;
wherein a blocking wall is arranged between two magnetic steels arranged on a same side; the blocking wall is extended from the end face of the step; the blocking wall blocks the two magnetic steels arranged on the same side in a direction in which the two magnetic steels are exposed to the shell.

10. The relay with the magnetic steels for arc extinguishing according to claim 5, wherein a housing of the main body portion is made of a magnetic conductive metal material; the housing at least covers an outer peripheral side of the driving piece to perform electromagnetic shielding.
